(19) United States
(12) Patent Application Publication
(10) Pub. No.: US 2023/0351410 A1
(43) Pub. Date: Nov. 2, 2023

(54) SYSTEM AND METHOD FOR RECOGNITION OF AN AUTHENTIC PRODUCT

(71) Applicant: SAI KUMAR JAMALPUR, HYDERABAD (IN)

(72) Inventor: SAI KUMAR JAMALPUR, HYDERABAD (IN)

(21) Appl. No.: 17/641,858

(22) PCT Filed: Dec. 11, 2020
(86) PCT No.: PCT/IB2020/061811

§ 371 Date: Mar. 10, 2022

(30) Foreign Application Priority Data
Oct. 27, 2020 (IN) 202041046744

(51) Int. Cl. G06Q 30/018; H04L 9/08; G06K 19/14

(52) U.S. Cl. CPC G06Q 30/0185; H04L 9/0861; G06K 19/14

(57) ABSTRACT

A system for recognition of authentic product is disclosed. The system includes a product tracking device affixed with a product which includes a first unique key generated using a light encryption technique, a second unique key to encrypt product information using a data encryption technique. A tracking device reader including a location tracking device to obtain a geographical location associated with movement of the product in one or more stages of supply chain process, a random key generator to generate a random key for mapping with the second unique key, to read the device identification number corresponding to the product, to encrypt the random key generated, the geographical location obtained, and the device identification number read corresponding to the product. An end-user computing device to scan the first unique key, to read product data encrypted within the first unique key, transmits the product data, verifies an authenticity of the product.

### CROSS-REFERENCE TO RELATED APPLICATION

This National Phase Application claims priority from a complete patent application filed in India having Patent Application No. 202041046744, filed on Oct. 27, 2020 and titled “SYSTEM AND METHOD FOR RECOGNITION OF AN AUTHENTIC PRODUCT”.

### BACKGROUND

Embodiments of the present disclosure relate to product tracking device and more particularly to a system and a method for recognition of an authentic product.

Counterfeits, replicas, fakes and illegal products are among the top challenges for many consumer brands globally. Counterfeiting of one or more kinds of products such as luxury products or everyday consumable products has become a widespread practice and as a result creating huge risks and losses for one or more industries associated with such products. The counterfeits or duplicate products are not only unsatisfactory for consumers but also affects reputation of the manufacturing industries associated with such counterfeiting products. There is a growing need for the consumers to ensure that the products that are bought in, from a traditional business, from the internet or between private individuals, needs to be checked whether used or consumed, or are original. Various systems are available which reduces manual efforts for checking the authenticity of the products.

Conventionally, the system available for product authentication includes a tag which is pasted on the on the product or wired with the product to provide unique information associated with the product. However, such a conventional system utilises a basic scanning mechanism of the scanning device available with the consumer. Such a system with the basic scanning mechanism is unable to scan the tag pasted with the product properly and hence generates inaccurate scanning results which further creates difficulty in extracting relevant product information. Also, such a conventional system after obtaining a proper tag scanning result, is capable of identifying only the authenticity or non-authenticity of the product without knowing any actual state or stages of the product from manufacturing till delivery process. Moreover, such a conventional system faces several data insecurity and data loss issues due to usage of insecure tags associated with the product.

Hence, there is a need for an improved system and a method for recognition of an authentic product in order to address the aforementioned issues.

### BRIEF DESCRIPTION

In accordance with an embodiment of a present disclosure, a system for recognition of an authentic product is disclosed. The system includes a product tracking device affixed with a product. The product tracking device includes a first unique key associated with the product. The first unique key is embossed on the product tracking device, wherein the first unique key is generated using a light encryption technique. The product tracking device also includes a second unique key representative of a device identification number corresponding to the product. The second unique key is configured to encrypt product information using a data encryption technique. The system also includes a tracking device reader operatively coupled to the product tracking device. The tracking device reader includes a location tracking device configured to obtain a geographical location associated with movement of the product in one or more stages of supply chain process. The tracking device receiver also includes a random key generator operatively coupled to the tracking device. The random key generator is configured to generate a random key for mapping with the second unique key representative of the device identification number. The random key generator is also configured to read the device identification number corresponding to the product based on the mapping of the random key generated with the second unique key. The random key generator is also configured to encrypt the random key generated, the geographical location obtained, and the device identification number read corresponding to the product. The system also includes a communication unit configured to transmit encrypted data representative of the random key, the geographical location and the device identification number to a centralized product database hosted on a remote server. The system also includes an end-user computing device associated with an end-user. The end-user computing device is configured to scan the first unique key embossed on the product tracking device affixed with the product using an end-user scanner installed within the end-user computing device. The end-user computing device also reads product data encrypted within the first unique key upon scanning using an object recognition technique and an image segmentation technique. The end-user computing device is also configured to transmit the product data, upon reading, to the centralized database hosted on the remote server. The end-user computing device is also configured to compare the product data read at an end-user's point with the product information stored on the centralized database, wherein the product information is obtained by decrypting the encrypted data transmitted by the tracking device. The end-user computing device is also configured to verify an authenticity of the product based on a matching result obtained upon comparison of the product data with the product information. The end-user computing device is also configured to generate an authentication notification to alert the end-user based on the authenticity of the product verified.

In accordance with another embodiment of the present disclosure, a method for recognition of an authentic product is disclosed. The method includes generating, using a light encryption technique, a first unique key associated with a product, wherein the first unique key is embossed on a product tracking device affixed with the product. The method also includes encrypting, by a second unique key of the product tracking device, product information using a data encryption technique. The method also includes obtaining, by a location tracking device, a geographical location associated with movement of the product in one or more stages of supply chain process. The method also includes generating, by a random key generator, a random key for mapping with the second unique key representative of the device identification number. The method also includes reading, by the random key generator, the device identification number corresponding to the product based on the mapping of the random key generated with the second unique key. The method also includes encrypting, by the random key generator, the random key generated, the geographical location obtained, and the device identification number read corresponding to the product. The method also includes transmitting, by a communication unit, encrypted data representative of the random key, the geographical location and the device identification number to a centralized product database hosted on a remote server, the method also includes scanning, by an end-user computing device, the first unique key embossed on the product tracking device affixed with the product using an end-user scanner installed within the end-user computing device. The method also includes reading, by the end-user computing device, product data encrypted within the first unique key upon scanning using an object recognition technique and an image segmentation technique. The method also includes transmitting, by the end-user computing device, the product data, upon reading, to the centralized database hosted on the remote server. The method also includes comparing, by the end-user computing device, the product data read at an end-user's point with the product information stored on the centralized database, wherein the product information is obtained by decrypting the encrypted data transmitted by the tracking device. The method also includes verifying, by the end-user computing device, an authenticity of the product based on a matching result obtained upon comparison of the product data with the product information. The method also includes generating, by the end-user computing device, an authentication notification to alert the end-user based on the authenticity of the product verified.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for recognition of an authentic product in accordance with an embodiment of the present disclosure:

FIG. 2 is a block diagram of an exemplary system for recognition of an authentic product in accordance with an embodiment of the present disclosure:

FIG. 3 illustrates a block diagram of a computer or a server of FIG. 1 in accordance with an embodiment of the present disclosure; and

FIG. 4 (a) and FIG. 4(b) represents a flow chart illustrating the steps involved in a method for recognition of an authentic product of a system of FIG. 1 in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for recognition of an authentic product. The system includes a product tracking device affixed with a product. The product tracking device includes a first unique key associated with the product. The first unique key is embossed on the product tracking device, wherein the first unique key is generated using a light encryption technique. The product tracking device also includes a second unique key representative of a device identification number corresponding to the product. The second unique key is configured to encrypt product information using a data encryption technique. The system also includes a tracking device reader operatively coupled to the product tracking device. The tracking device reader includes a location tracking device configured to obtain a geographical location associated with movement of the product in one or more stages of supply chain process. The tracking device receiver also includes a random key generator operatively coupled to the location tracking device. The random key generator is configured to generate a random key for mapping with the second unique key representative of the device identification number. The random key generator is also configured to read the device identification number corresponding to the product based on the mapping of the random key generated with the second unique key. The random key generator is also configured to encrypt the random key generated, the geographical location obtained, and the device identification number read corresponding to the product. The tracking device reader also includes a communication unit configured to transmit encrypted data representative of the random key, the geographical location and the device identification number to a centralized product database hosted on a remote server. The system also includes an end-user computing device associated with an end-user. The end-user computing device is configured to scan the first unique key embossed on the product tracking device affixed with the product using an end-user scanner installed within the end-user computing device. The end-user computing device also reads product data encrypted within the first unique key upon scanning using an object recognition technique and an image segmentation technique. The end-user computing device is also configured to transmit the product data, upon reading, to the centralized database hosted on the remote server. The end-user computing device is also configured to compare the product data read at an end-user's point with the product information stored on the centralized database, wherein the product information is obtained by decrypting the encrypted data transmitted by the tracking device. The end-user computing device is also configured to verify an authenticity of the product based on a matching result obtained upon comparison of the product data with the product information. The end-user computing device is also configured to generate an authentication notification to alert the end-user based on the authenticity of the product verified.

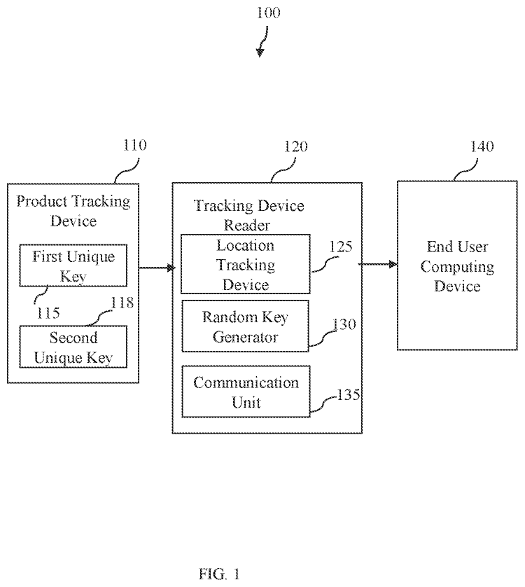

FIG. 1 is a block diagram of a system 100 for recognition of an authentic product in accordance with an embodiment of the present disclosure. The system 100 includes a product tracking device 110 affixed with a product. In one embodiment, the product may include at least one of an electronic product, a medical product, a house-hold product, a food product, a cosmetic product, a stationary product, an accessory or a combination thereof. In some embodiment, the product tracking device may include an integrated circuit chip. In another embodiment, the product tracking device may include a portable electro-mechanical device. In such embodiment, the product tracking device is affixed with the product via a wireless communication protocol or a wired communication protocol. In such embodiment, the wireless communication protocol may include, but not limited to, Bluetooth® low energy BLE communication protocol, Zigbee® communication protocol, near field communication protocol (NFC) and the like. In another embodiment, the wired communication protocol may include communication via a universal serial bus (USB) cable.

The product tracking device 110 includes a first unique key 115 associated with the product. The first unique key is embossed on the product tracking device, wherein the first unique key is generated using a light encryption technique. In one embodiment, the first unique key may include a visible key. In such embodiment, the visible key may include at least one of a geometrical shape, a barcode, a quick response code, an alphanumeric code, a pattern, a hologram, a multidimensional image or a combination thereof. As used herein, the term ‘light encryption technique’ is defined as an encryption technique which utilises particles of light originated from a source to encrypt information for secured communication.

The product tracking device also includes a second unique key 118 representative of a device identification number corresponding to the product. The second unique key is configured to encrypt product information using a data encryption technique. In one embodiment, the second unique key may include a private key. In such embodiment, the second unique may include a static private key. In another embodiment, the second unique key may include a dynamic private key. In one embodiment, the private key is generated by an encryption engine. In a specific embodiment, the product information may include at least one of a product identification number, a location of product manufacturing unit, details of one or more substages of a supply chain process associated with the product, a product packaging details, a delivery location associated with the product or a combination thereof. In one embodiment, the data encryption technique may include at least one of an advanced encryption standard technique, a data encryption standard technique, a Rivest-Shamir-Adleman (RSA) encryption technique or a blowfish encryption technique.

The system 100 also includes a tracking device reader 120 operatively coupled to the product tracking device 110. In one embodiment, the tracking device reader 120 may be used by manufacturer, a logistics company or a supplier of the product to track an actual state of the product. The tracking device reader includes a location tracking device 125 configured to obtain a geographical location associated with movement of the product in one or more stages of supply chain process. In one embodiment, the location tracking device may include a navigational transceiver which may include a global positioning system (GPS) transceiver. The GPS transceiver transmits or receives the geographical location associated with the movement of the product in the one or more stages of the supply chain process. In another embodiment, the location tracking device may be connected to wireless communication network for fetching internet protocol (IP) address of a geo-location. In one embodiment, the one or more stages may include, but not limited to, a planning stage, a manufacturing stage, a delivering stage, a return stage and the like. The GPS transceiver that is inbuilt within the tracking device reader itself or connected via wireless communication technology. The tracking device reader 120 also includes a random key generator 130 operatively coupled to the location tracking device 125. The random key generator is configured to generate a random key for mapping with the second unique key representative of the device identification number. In one embodiment, the random key generator may generate a plurality of true random numbers or a plurality of pseudo-random numbers to generate a public-private key pair.

The random key generator is also configured to read the device identification number (ID) corresponding to the product based on the mapping of the random key generated with the second unique key. In one embodiment, the device ID may be unique corresponding to each of the product. The random key generator is also configured to encrypt the random key generated, the geographical location obtained, and the device identification number read corresponding to the product. The tracking device reader is used at multiple stages of the supply chain process to record the movement of the product. The tracking device reader reads the tracking device based on an agreed protocol.

The tracking device reader also includes a communication unit 135 configured to transmit encrypted data representative of the random key, the geographical location and the device identification number to a centralized product database hosted on a remote server. In some embodiment, the remote server may include a cloud server. In one embodiment, the centralized database may store the product information, and the encrypted data transmitted. In one embodiment, the communication unit may include, but not limited to a wireless communication chip embedded on the communication unit of the tracking device reader. In such embodiment, the wireless communication chip may enable communication with the remote server via Bluetooth® low energy (BLE) communication protocol, Zigbee® communication protocol, near field communication protocol (NFC) and the like. In another embodiment, the wired communication protocol may include communication via a universal serial bus (USB) cable.

The system 100 also includes an end-user computing device 140 associated with an end-user. In one embodiment, the end-user computing device may include, but not limited to, a mobile phone, a laptop, a desktop, a tablet, a personal digital assistant (PDA) and the like. The end-user computing device is configured to scan the first unique key embossed on the product tracking device affixed with the product using an end-user scanner installed within the end-user computing device. The end-user computing device also reads product data encrypted within the first unique key upon scanning using an object recognition technique and an image segmentation technique. The image segmentation technique partitions the scanned image into multiple segments. Based on the multiple segments of the image, one or more objects present in the images are recognized.

The end-user computing device 140 is also configured to transmit the product data, upon reading, to the centralized database hosted on the remote server. The centralized database includes cross mapping of the first unique key with the product or its attributes and identifiers, proprietary to the product manufacturer. The end-user computing device is also configured to compare the product data read at an end-user's point with the product information stored on the centralized database, wherein the product information is obtained by decrypting the encrypted data transmitted by the tracking device. In one embodiment, the product data may include at least one of the product identification number, date of manufacturing, place of manufacturing, ordering date of the product, shipment date of the product, delivery date of the product, price of the product, route of delivery associated with the product or a combination thereof.

The end-user computing device is also configured to verify an authenticity of the product based on a matching result obtained upon comparison of the product data with the product information. The end-user computing device is also configured to generate an authentication notification to alert the end-user based on the authenticity of the product verified. In one embodiment, the authentication notification may include, but not limited to, a push notification, a pop notification, an alarm message or a call.

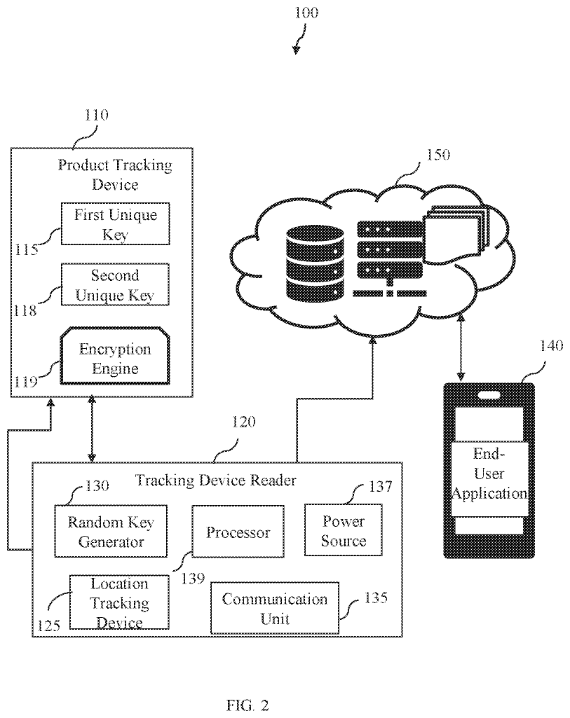

FIG. 2 is a block diagram of an exemplary system 100 for recognition of an authentic product in accordance with an embodiment of the present disclosure. The system 100 is a product authentication system which is useful for an end-user of a business to business (B2B) platform as well as a business to consumer (B2C) platform. The system 100 is applicable for the product authentication of any kind of luxurious or essential products belonging to any industry. Considering an example, wherein the system 100 is utilized by an end-user for checking authenticity of a medicinal product such as a drugs. Nowadays counterfeiting of the drugs have become a common practice and in case if not verified properly before usage, there is a chance of occurrence of one or more health problems or side-effects. The system 100 for checking the authenticity of the drugs incudes a product tacking device 110 which is affixed with the drugs. Suppose if the drugs used in this example is ‘Paracetamol’, then for each strip of the drug ‘Azithromycin, the product tracking device is affixed. For example, the product tracking device may include an integrated circuit (IC) chip or a tiny electro-mechanical device.

The product tracking device 110 is powered by a wireless fidelity network to communicate with an end-user device. The product tracking device 110 also includes a first unique key 115 associated with the product. The first unique key is embossed on the product tracking device, wherein the first unique key is generated using a light encryption technique. For example, the first unique key may include a visible key which may include at least one of a geometrical shape, a barcode, a quick response code, an alphanumeric code, a pattern, a hologram, a multidimensional image or a combination thereof.

Also, there is a second unique key 118 written on the product tracking device 110. Here, the second unique key is a representative of a device identification number corresponding to the product. The second unique key is generated by an encryption engine 119. The second unique key is configured to encrypt product information using a data encryption technique. In the example used herein, the second unique key may include a static private key. In the example used herein, the product information may include a product identification number, a location of product manufacturing unit, details of one or more substages of a supply chain process associated with the product, a product packaging details, a delivery location associated with the product or a combination thereof. Again, the data encryption technique may include at least one of, a Rivest-Shamir-Adleman (RSA) encryption technique.

Once, the product tracking is recorded, the system 100 also includes a tracking device reader 120 which may be used by manufacturer, a logistics company or a supplier of the product to track an actual state of the product. The tracking device reader 120 includes a location tracking device such as a GPS transceiver 125 configured to obtain a geographical location associated with movement of the product in one or more stages of supply chain process. The tracking device reader also includes a random key generator 130 which generates a random key for mapping with the second unique key representative of the device identification number.

Based on the mapping done, the random key generator reads the device identification number (ID) corresponding to the product. The reading of the device ID helps in linkage of the product and interpreting the product information. The random key generator 130 is also configured to encrypt the random key generated, the geographical location obtained, and the device identification number read corresponding to the product. The tracking device reader also includes a power source 137 and a processor 139 unit. Also, the tracking device reader includes a communication unit 135 configured to transmit encrypted data representative of the random key, the geographical location and the device identification number to a centralized product database hosted on a remote server. For example, the remote server may include a cloud server 150. For example, the communication unit may include, but not limited to a wireless communication chip embedded on the communication unit of the tracking device reader. The wireless communication chip may enable communication with the remote server via Bluetooth® low energy (BLE) communication protocol, Zigbee® communication protocol, near field communication protocol (NFC) and the like.

Further once, the drugs are received by the end-user at an end user point, the end-user utilizes the end-user computing device 140 which may include a mobile phone. The end-user computing device 140 installs end user application which is configured to scan the first unique key embossed on the product tracking device affixed with the product using an end-user scanner installed within the end-user computing device. Upon scanning, the end-user computing device also reads product data encrypted within the first unique key using an object recognition technique and an image segmentation technique. Based on the reading, the end-user computing device transmits the product data to the centralized database hosted on the remote server. The centralized database includes cross mapping of the first unique key with the product or its attributes and identifiers, proprietary to the product manufacturer. Apart from this, the end-user computing device also compares the product data read at an end-user's point with the product information stored on the centralized database, wherein the product information is obtained by decrypting the encrypted data transmitted by the tracking device. In the example used herein, the product data may include at least one of the product identification number, date of manufacturing, place of manufacturing, ordering date of the product, shipment date of the product, delivery date of the product, price of the product, route of delivery associated with the product or a combination thereof.

Upon obtaining a matching result based on comparison, the end-user computing device verifies an authenticity of the product. Further based on the authenticity generated, the end-user computing device is also configured to generate an authentication notification to alert the end-user. For example, the authentication notification may include an establishment of authentic and a genuine product received from the server. Thus, the verification of the authenticity of the product improves end-user's satisfaction and also avoids rise in counterfeiting of the products easily.

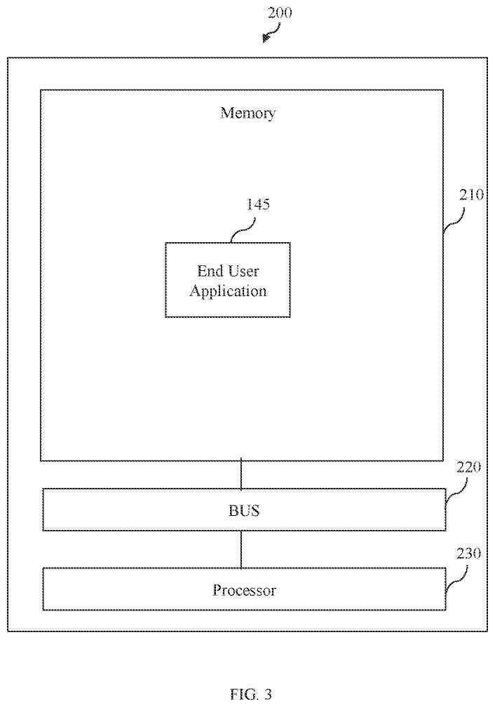

FIG. 3 illustrates a block diagram of a computer or a server of FIG. 1 in accordance with an embodiment of the present disclosure. The server 200 includes processors 230, and memory 210 operatively coupled to the bus 220. The processors 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 is substantially similar to an end user application 145 installed within an end-user computing device 140 associated with the end-user of FIG. 1. The memory 210 includes an end user platform of the end-user computing device.

The end-user application 145 of the end-user computing device 140 is configured to scan the first unique key embossed on the product tracking device affixed with the product using an end-user scanner installed within the end-user computing device. The end-user application of the end-user computing device also reads product data encrypted within the first unique key upon scanning using an object recognition technique and an image segmentation technique. The end-user application of the end-user computing device is also configured to transmit the product data, upon reading, to the centralized database hosted on the remote server. The end-user application of the end-user computing device is also configured to compare the product data read at an end-user's point with the product information stored on the centralized database, wherein the product information is obtained by decrypting the encrypted data transmitted by the tracking device. The end-user application of the end-user computing device is also configured to verify an authenticity of the product based on a matching result obtained upon comparison of the product data with the product information. The end-user computing device is also configured to generate an authentication notification to alert the end-user based on the authenticity of the product verified.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

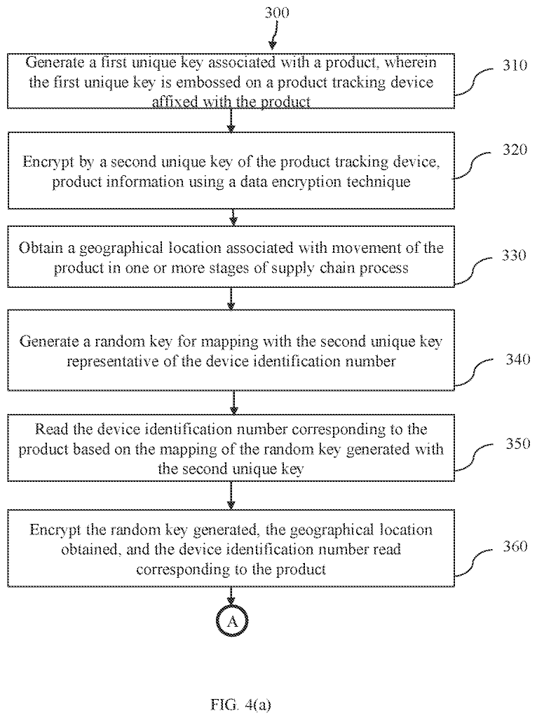

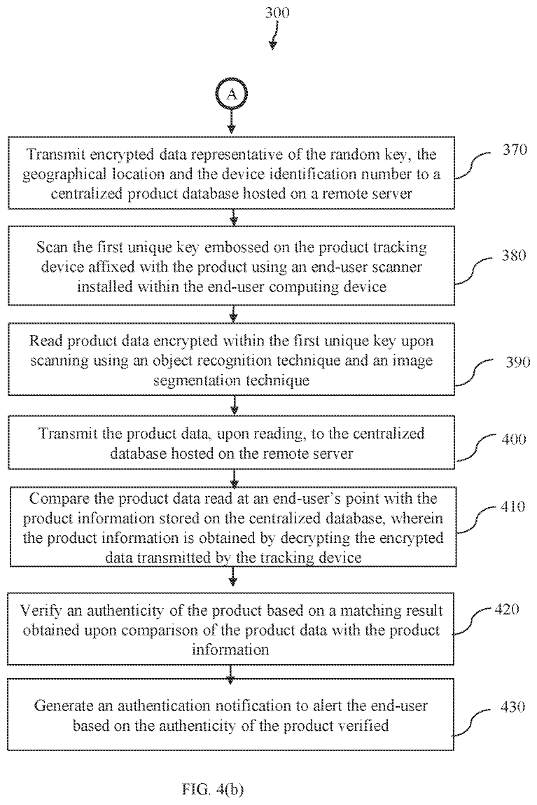

FIG. 4 is a flow chart representing the steps involved in a method 300 for recognition of an authentic product of a system of FIG. 1 in accordance with the embodiment of the present disclosure. The method 300 includes generating, using a light encryption technique, a first unique key associated with a product, wherein the first unique key is embossed on a product tracking device affixed with the product in step 310. In one embodiment, generating the first unique key associated with the product may include generating the first unique key associated with at least one of an electronic product, a medical product, a house-hold product, a food product, a cosmetic product, a stationary product, an accessory or a combination thereof. In some embodiment, generating the first unique key associated with the product may include generating a visible key. In such embodiment, the first unique key may include at least one of a geometrical shape, a barcode, a quick response code, an alphanumeric code, a pattern, a hologram, a multidimensional image or a combination thereof.

The method 300 also includes encrypting, by a second unique key of the product tracking device, product information using a data encryption technique in step 320. In one embodiment, encrypting the product information by the second unique key may include encrypting the product information by a private key. In such embodiment, the second unique may include a static private key. In another embodiment, the second unique key may include a dynamic private key. In one embodiment, the private key is generated by an encryption engine. In a specific embodiment, the product information may include at least one of a product identification number, a location of product manufacturing unit, details of one or more substages of a supply chain process associated with the product, a product packaging details, a delivery location associated with the product or a combination thereof.

The method 300 also includes obtaining, by a location tracking device, a geographical location associated with movement of the product in one or more stages of supply chain process in step 330. In one embodiment, obtaining the geographical location associated with the movement of the product in the one or more stages of the supply chain process may include obtaining the geographical location by a global positioning system (GPS) transceiver. In another embodiment, obtaining the geographical location of a place may include obtaining the geographical location of a place by fetching internet protocol (IP) address via a wireless communication network. In some embodiment, obtaining the geographical location associated with the movement of the product in the one or more stages of the supply chain process may include obtaining the geographical location associated with the movement of the product in the one or more stages which may include, but not limited to, a planning stage, a manufacturing stage, a delivering stage, a return stage and the like.

The method 300 also includes generating, by a random key generator, a random key for mapping with the second unique key representative of the device identification number in step 340. In one embodiment, generating the random key for mapping with the second unique key may include generating the random key based on a true random number or a pseudo-number generated by the random key generator.

The method 300 also includes reading, by the random key generator, the device identification number corresponding to the product based on the mapping of the random key generated with the second unique key in step 350. The method 300 also includes encrypting, by the random key generator, the random key generated, the geographical location obtained, and the device identification number read corresponding to the product in step 360.

The method 300 also includes transmitting, by a communication unit, encrypted data representative of the random key, the geographical location and the device identification number to a centralized product database hosted on a remote server in step 370. In one embodiment, transmitting the encrypted data representative of the random key, the geographical location and the device identification number may include transmitting the encrypted data which is encrypted using at least one of an advanced encryption standard technique, a data encryption standard technique, a Rivest-Shamir-Adleman (RSA) encryption technique or a blowfish encryption technique.

The method 300 also includes scanning, by an end-user computing device, the first unique key embossed on the product tracking device affixed with the product using an end-user scanner installed within the end-user computing device in step 380. In one embodiment, scanning the first unique key embossed on the product tracking device may include scanning the first unique key by the end-user scanner installed within at least one of a mobile phone, a laptop, a desktop, a tablet, a personal digital assistant (PDA) and the like. The method 300 also includes reading, by the end-user computing device, product data encrypted within the first unique key upon scanning using an object recognition technique and an image segmentation technique in step 390.

The method 300 also includes transmitting, by the end-user computing device, the product data, upon reading, to the centralized database hosted on the remote server in step 400. In some embodiment, transmitting the product data to the centralized database hosted on the remote server may include transmitting at least one of the product identification number, date of manufacturing, place of manufacturing, ordering date of the product, shipment date of the product, delivery date of the product, price of the product, route of delivery associated with the product or a combination thereof.

The method 300 also includes comparing, by the end-user computing device, the product data read at an end-user's point with the product information stored on the centralized database, wherein the product information is obtained by decrypting the encrypted data transmitted by the tracking device in step 410. The method 300 also includes verifying, by the end-user computing device, an authenticity of the product based on a matching result obtained upon comparison of the product data with the product information in step 420.

The method 300 also includes generating, by the end-user computing device, an authentication notification to alert the end-user based on the authenticity of the product verified in step 430. In one embodiment, generating the authentication notification to alert the end-user may include generating the authentication notification, including, but not limited to, a push notification, a pop notification, an alarm message or a call.

Various embodiments of the present disclosure relate to a system which is capable of identifying the authenticity of the product by performing detailed analysis of actual states of the product within the supply chain processes and thus helps in quick identification of exact reason and stage of counterfeit products.

Moreover, the present disclosed system utilizes the object detection and the image segmentation technique for improving accuracy in reading the data from scanned result of the visible key. Hence, improved accuracy in reading the data helps in extracting relevant product information without wastage of time and effort.

Furthermore, the present disclosed system includes a product tracking device which generally avoids the chances of damage of the tags which are mainly pasted on the product. Also, the presence of the product tracking device with a power source helps in making connection with the end-user as well as with manufacturers or the supply chain personnel to keep updated about the status of the product.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A system for recognition of an authentic product comprising:
a product tracking device affixed with a product, wherein the product tracking device comprises:
a first unique key associated with the product, wherein the first unique key is embossed on the product tracking device, wherein the first unique key is generated using a light encryption technique; and
a second unique key representative of device identification number corresponding to the product, wherein the second unique key is configured to encrypt product information using a data encryption technique:
a tracking device reader operatively coupled to the product tracking device, wherein the tracking device reader comprises:
a location tracking device configured to obtain a geographical location associated with movement of the product in one or more stages of supply chain process;
a random key generator operatively coupled to the location tracking device, wherein the random key generator is configured to:
generate a random key for mapping with the second unique key representative of the device identification number,
read the device identification number corresponding to the product based on the mapping of the random key generated with the second unique key; and
encrypt the random key generated, the geographical location obtained, and the device identification number read corresponding to the product; and
a communication unit configured to transmit encrypted data representative of the random key, the geographical location and the device identification number to a centralized product database hosted on a remote server; and
an end-user computing device associated with an end-user, wherein the end-user computing device is configured to:
scan the first unique key embossed on the product tracking device affixed with the product using an end-user scanner installed within the end-user computing device;
read product data encrypted within the first unique key upon scanning using an object recognition technique and an image segmentation technique:
transmit the product data, upon reading, to the centralized database hosted on the remote server;
compare the product data read at an end-user's point with the product information stored on the centralized database, wherein the product information is obtained by decrypting the encrypted data transmitted by the tracking device;
verify an authenticity of the product based on a matching result obtained upon comparison of the product data with the product information; and
generate an authentication notification to alert the end-user based on the authenticity of the product verified.

2. The system as claimed in claim 1, wherein the product comprises at least one of an electronic product of a manufacturing industry, a medical product, a chemical product produced by a chemical industry, a house-hold product manufactured, a food product, a cosmetic product, a stationary product, an accessory or a combination thereof.

3. The system as claimed in claim 1, wherein the product tracking device comprises an integrated circuit chip or a portable electro-mechanical device.

4. The system as claimed in claim 1, wherein the product tracking device is affixed with the product via a wireless communication protocol or a wired communication protocol.

5. The system as claimed in claim 1, wherein the first unique key comprises a visible key, wherein the first unique key comprises at least one of a geometrical shape, a barcode, a quick response code, an alphanumeric code, a pattern a hologram, a multidimensional image or a combination thereof.

6. The system as claimed in claim 1, wherein the second unique key comprises a private key, wherein the second unique key is generated by an encryption engine.

7. The system as claimed in claim 1, wherein the product information comprises at least one of a product identification number, a location of product manufacturing unit, details of one or more substages of a supply chain process associated with the product, a product packaging details, a delivery location associated with the product or a combination thereof.

8. The system as claimed in claim 1, wherein the product data comprises at least one of the product identification number, date of manufacturing, place of manufacturing, ordering date of the product, shipment date of the product, delivery date of the product, price of the product, route of delivery associated with the product or a combination thereof.

9. A method comprising:
generating, using a light encryption technique, a first unique key associated with a product, wherein the first unique key is embossed on a product tracking device affixed with the product;
encrypting, by a second unique key of the product tracking device, product information using a data encryption technique;
obtaining, by a location tracking device, a geographical location associated with movement of the product in one or more stages of supply chain process;
generating, by a random key generator, a random key for mapping with the second unique key representative of the device identification number;
reading, by the random key generator, the device identification number corresponding to the product based on the mapping of the random key generated with the second unique key;
encrypting, by the random key generator, the random key generated, the geographical location obtained, and the device identification number read corresponding to the product;
transmitting, by a communication unit, encrypted data representative of the random key, the geographical location and the device identification number to a centralized product database hosted on a remote server;
scanning, by an end-user computing device, the first unique key embossed on the product tracking device affixed with the product using an end-user scanner installed within the end-user computing device;
reading, by the end-user computing device, product data encrypted within the first unique key upon scanning using an object recognition technique and an image segmentation technique;
transmitting, by the end-user computing device, the product data, upon reading, to the centralized database hosted on the remote server;
comparing, by the end-user computing device, the product data read at an end-user's point with the product information stored on the centralized database, wherein the product information is obtained by decrypting the encrypted data transmitted by the tracking device;
verifying, by the end-user computing device, an authenticity of the product based on a matching result obtained upon comparison of the product data with the product information; and
generating, by the end-user computing device, an authentication notification to alert the end-user based on the authenticity of the product verified.
